(19) United States
(12) Patent Application Publication
(10) Pub. No.: US 2026/0138545 A1
(43) Pub. Date: May 21, 2026

(54) METHOD FOR RESETTING A TAILGATE CONTROL UNIT

(71) Applicant: AUDI AG, lngolstadt (DE)

(72) Inventor: Christian KUPFER, Pinzberg (DE)

(73) Assignee: AUDI AG, lngolstadt (DE)

(21) Appl. No.: 19/317,255

(22) Filed: Sep. 3, 2025

(30) Foreign Application Priority Data
Nov. 21, 2024 (DE) 102024134176.9

(51) Int. Cl. B60R 16/023; E05F 15/70; G07C 5/08

(52) U.S. Cl. CPC B60R 16/0232; E05F 15/70; G07C 5/0841; E05Y 2900/546

(57) ABSTRACT

A method for resetting a control unit controlling a tailgate movement of a tailgate. A control error of the tailgate of a vehicle is registered, and at least two control signals are generated simultaneously and received by the control unit. Based on the simultaneously received control signals at least one value stored in the control unit is deleted and/or reset to an initial value.

### FIELD

The invention relates to a method for resetting a control unit controlling a tailgate movement of a tailgate. Furthermore, the invention relates to a control unit and vehicle.

### BACKGROUND

Vehicles with electronically powered tailgates are known. Such tailgates are changed in their opening angle by actuators at a defined speed and can have sensors for obstacle detection. A control unit is used to control the actuator and to evaluate the measurement data received from the sensors. If such a control unit, a so-called tailgate control unit or a tailgate software module of a control unit, incorrectly stores important values for the end position of the tailgate or for the electrical opening or closing of the tailgate, the driver must regularly visit a workshop to have these incorrect values deleted, because this could result in the tailgate having a faulty end stop, an incorrect opening speed or no function. Only after such a reset of the control unit can the tailgates function as usual again.

DE 10 2013 222 579 A1 describes a method and a device for determining/recording a maximum opening angle of a side door of a vehicle. The maximum opening angle of the side door is limited when the side door is opened again as long as the vehicle is stationary.

DE 10 2006 039 257 A1 discloses a method for adjusting a movable body part, in particular a tailgate. A control unit performs a recalibration process with regard to position values at specific times.

### SUMMARY

It is the object of the present invention to provide a method by which a user can easily reset a tailgate control unit without having to visit a workshop.

The method according to the invention serves to reset a control unit controlling a tailgate movement of a tailgate. In one step of the method, a faulty control of the tailgate of a vehicle is registered by the control unit. The control malfunction can be determined by the control unit itself or by observation by a user of the vehicle. For example, a deviation in the functioning of the tailgate from a regular functioning of the tailgate can be caused by a faulty control of the tailgate. Such a deviation can, for example, cause a change in the opening or closing speed and/or a change in the end stop of the tailgate.

At least two control signals are generated simultaneously and received by the control unit. Based on the control signals received at the same time, at least one value stored in the control unit is deleted and/or reset to an initial value.

According to a further aspect of the invention, a control unit is provided which is configured to carry out the method according to the invention. The control unit can be designed as a tailgate control unit or be responsible for several different functions and actuators, wherein a tailgate software module is implemented in the control unit, which is configured to control at least one actuator of the tailgate.

According to a further aspect of the invention, a vehicle is provided. The vehicle has a tailgate movable by at least one actuator, wherein the at least one actuator can be controlled by a control unit according to the invention. The control unit is further connected to at least one sensor of the vehicle in a data-conducting manner and is configured to receive control signals from the at least one sensor.

If the tailgate no longer moves properly, for example due to a travel speed that is too high or too low and/or an incorrectly operating obstacle detection and/or an incorrect upper end position and the like, the method enables a user-defined reset. According to one embodiment, such a resetting of the control unit can be carried out via a key combination and the stored values for, for example, the travel speed, zones or end stops can be deleted in order to carry out a new learning run of the tailgate or the control unit responsible for the tailgate.

Advantageously, a software algorithm or memory area can be used to ensure that only values that have no influence on the excess force limitation or on the so-called anti-pinch functions are deleted and/or reset.

In a further exemplary embodiment, the at least two control signals are generated by actuating at least two keys on the vehicle. For example, simultaneous actuation of a soft-touch area on the vehicle and a tailgate interior button for a parametrizable time can initiate deletion and/or resetting of at least one value. This measure represents a particularly simple technical solution.

According to a further embodiment, the at least two control signals are generated by an input in an infotainment system of the vehicle, wherein the control signals are generated in the form of Controller Area Network (CAN) signals and transmitted to the control unit. This allows the vehicle user to delete and/or reset at least one value via a menu in the vehicle's infotainment system. This makes the method particularly convenient to perform.

According to a further exemplary embodiment, the at least two control signals are generated by actuating two ground contacts. This measure enables a technically particularly simple generation of signals that can be registered by the control unit.

According to a further embodiment, the at least one value stored in the control unit is deleted and/or reset to an initial value when the at least two control signals are received by the control unit for a predefined period of time. The elapse of the time period can be acknowledged or confirmed by an optical and/or acoustic signal. Such a signal can be generated by the control unit and sent to at least one vehicle-side output unit. For example, an output unit can be implemented in the form of warning lights to signal to the user a successful reset of at least one value. The predefined time period can prevent unintentional deletion and/or resetting of the at least one value to an initial value.

However, if the signals are not maintained beyond the predefined time period, for example by releasing keys, the function can be aborted. In this case, the previously stored values remain in the NVRAM (Non-Volatile Random-Access Memory) of the control unit.

According to a further exemplary embodiment, after deleting and/or resetting the at least one value, a learning process is initiated upon subsequent actuation of the tailgate. This allows an automated learning process of the tailgate to be initiated after deleting and/or resetting the at least one value.

According to a further embodiment, at least one value for a travel speed of the tailgate and/or at least one value for an end stop of the tailgate and/or at least one value for obstacle detection is deleted and/or reset in the control unit. This allows the vehicle user to specifically delete and/or reset a large number of parameters relevant to the control of the tailgate in order to restore the correct functionality of the tailgate.

### BREIF DESCRIPTION OF THE FIGURES

The invention is schematically illustrated in the drawings with the aid of embodiments and is described further with reference to the drawings. In the figures:

FIG. 1 shows a vehicle according to an exemplary embodiment according to the invention.

FIG. 2 shows a schematic flow diagram to illustrate a method according to an exemplary embodiment of the invention.

Elements and components with the same or similar structural or functional features are provided with the same reference numerals throughout the figures.

### DETAILED DESCRIPTION

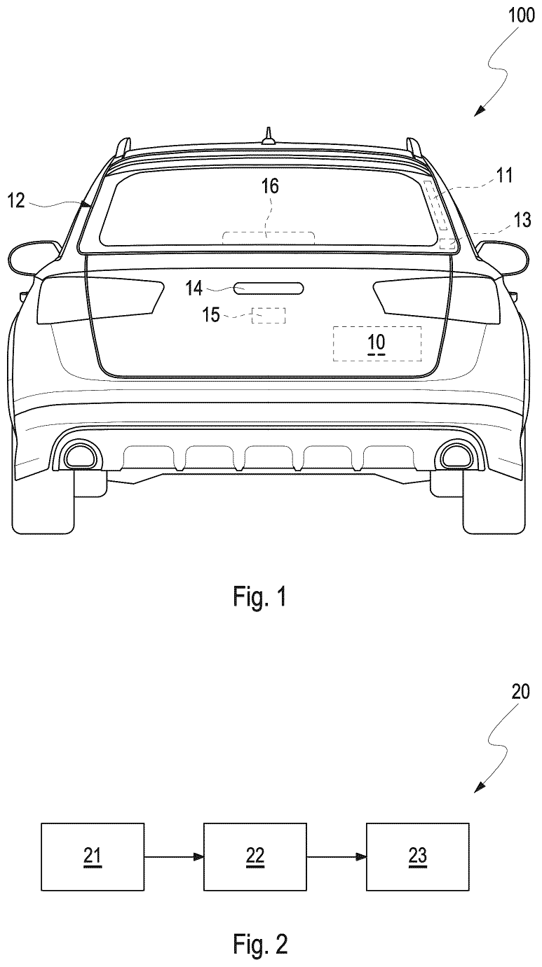

FIG. 1 shows a vehicle 100 according to an exemplary embodiment according to the invention. The vehicle 100 has a tailgate 12 movable by at least one actuator 11. The at least one actuator 11 can be controlled by a control unit 10.

The control unit 10 is configured to carry out a method 20, which is described in more detail in FIG. 2.

The control unit 10 can be designed as a tailgate control device or be responsible for several different functions and actuators 11, wherein a tailgate software module is implemented in the control unit 10, which is configured to control at least one actuator 11 of the tailgate 12. The control unit 10 is further connected to at least one sensor 13 of the vehicle 100 in a data-conducting manner and is configured to receive control signals from the at least one sensor 13.

The sensor 13 can be designed as a distance sensor, for example as an ultrasonic sensor, camera sensor, infrared sensor and the like, and can contribute to determining a maximum opening angle of the tailgate 12.

If the tailgate 12 no longer moves properly, for example due to a travel speed that is too high or too low and/or an incorrectly operating obstacle detection and/or an incorrect upper end position and the like, the method enables a user-defined reset. According to one embodiment, such a resetting of the control unit 10 can be carried out via a key combination and the stored values for, for example, the travel speed, zones or end stops can be deleted in order to carry out a new learning run of the tailgate 12 or of the control unit 10 responsible for the tailgate 12.

The reset can be carried out, for example, by pressing two buttons 14, 15 on the vehicle 100 over a defined period of time. For example, simultaneous actuation of a soft-touch region 14 on the vehicle 100 and a tailgate interior button 15 for a parametrizable time can initiate deletion and/or resetting of the at least one value.

Alternatively or additionally, a user of the vehicle 100, not shown, can initiate the reset by generating two control signals through an input in an infotainment system 16 of the vehicle 100, wherein the control signals are generated in the form of CAN signals and transmitted to the control unit 10. This allows the at least one value to be deleted and/or reset via a menu of the infotainment system 16 of the vehicle 100.

FIG. 2 shows a schematic flow diagram to illustrate a method 20 according to an exemplary embodiment of the invention. The method 20 serves to reset a control unit 10 that controls a tailgate movement of the tailgate 12.

In a step 21 of the method 20, a control error of the tailgate 12 of the vehicle 100 is registered or detected by the control unit 10 or by a user, not shown. The control error can be detected, for example, by observing the user of the vehicle 100. A control error may be detectable or registerable by anomalies in the opening or closing speed and/or the end stop of the tailgate 12.

In a further step 22, at least two control signals are generated simultaneously and received by the control unit 10. Receiving preferably occurs for a predefined period of time to avoid unintentional resetting of the control unit 10.

Based on the control signals received at the same time, at least one value stored in the control unit is deleted and/or reset to an initial value in a further step 23.

### LIST OF REFERENCE NUMERALS

100 vehicle
10 control unit
11 actuator
12 tailgate
13 sensor
14 key/soft-touch region
15 key/tailgate interior button
16 infotainment system
20 method
21 registering a control error
22 receiving control signals
23 deleting and/or resetting values

1. A method for resetting a control unit controlling a tailgate movement of a tailgate, comprising: registering a control error of the tailgate of a vehicle; simultaneously generating and receiving at least two control signals by the control unit; wherein based on the simultaneously received control signals at least one value stored in the control unit is deleted and/or reset to an initial value.

2. The method according to claim 1, wherein the at least two control signals are generated by actuating at least two keys on the vehicle.

3. The method according to claim 1, wherein the at least two control signals are generated by an input in an infotainment system of the vehicle, wherein the control signals are generated in the form of CAN signals and transmitted to the control unit.

4. The method according to claim 1, wherein the at least two control signals are generated by actuating two ground contacts.

5. The method according to claim 1, wherein the at least one value stored in the control unit is deleted and/or reset to an initial value when the at least two control signals are received by the control unit for a predefined period of time.

6. The method according to claim 1, wherein after deleting and/or resetting the at least one value, a learning process is initiated upon subsequent actuation of the tailgate.

7. The method according to claim 1, wherein at least one value for a travel speed of the tailgate and/or at least one value for an end stop of the tailgate and/or at least one value for obstacle detection is deleted and/or reset in the control unit.

8. A control unit, configured to carry out a method according to claim 1.

9. A vehicle, comprising: a tailgate movable by at least one actuator, wherein the at least one actuator can be controlled by a control unit according to claim 8, wherein the control unit is connected to at least one sensor in a data-conducting manner and is configured to receive control signals.

10. The method according to claim 2, wherein the at least two control signals are generated by an input in an infotainment system of the vehicle, wherein the control signals are generated in the form of CAN signals and transmitted to the control unit.

11. The method according to claim 2, wherein the at least two control signals are generated by actuating two ground contacts.

12. The method according to claim 3, wherein the at least two control signals are generated by actuating two ground contacts.

13. The method according to claim 2, wherein the at least one value stored in the control unit is deleted and/or reset to an initial value when the at least two control signals are received by the control unit for a predefined period of time.

14. The method according to claim 3, wherein the at least one value stored in the control unit is deleted and/or reset to an initial value when the at least two control signals are received by the control unit for a predefined period of time.

15. The method according to claim 4, wherein the at least one value stored in the control unit is deleted and/or reset to an initial value when the at least two control signals are received by the control unit for a predefined period of time.

16. The method according to claim 2, wherein after deleting and/or resetting the at least one value, a learning process is initiated upon subsequent actuation of the tailgate.

17. The method according to claim 3, wherein after deleting and/or resetting the at least one value, a learning process is initiated upon subsequent actuation of the tailgate.

18. The method according to claim 4, wherein after deleting and/or resetting the at least one value, a learning process is initiated upon subsequent actuation of the tailgate.

19. The method according to claim 5, wherein after deleting and/or resetting the at least one value, a learning process is initiated upon subsequent actuation of the tailgate.

20. The method according to claim 2, wherein at least one value for a travel speed of the tailgate and/or at least one value for an end stop of the tailgate and/or at least one value for obstacle detection is deleted and/or reset in the control unit.
